(19) United States
(12) Patent Application Publication
(10) Pub. No.: US 2013/0193276 A1
(43) Pub. Date: Aug. 1, 2013

(54) SYSTEM FOR INDUCTIVE POWER TRANSFER AND ROBUST POSITION SENSING

(71) Applicant: Sandor Wayne Shapery, San Diego, CA (US)

(72) Inventor: Bradley Hunter, Burlington, MA (US)

(73) Assignee: Sandor Wayne Shapery, San Diego, CA (US)

(21) Appl. No.: 13/753,307

(22) Filed: Jan. 29, 2013

Related U.S. Application Data
(60) Provisional application No. 61/593,132, filed on Jan. 31, 2012.

(51) Int. Cl. B61L 25/02; G01S 1/02

(52) U.S. Cl. CPC B61L 25/026; G01S 1/02
USPC 246/122 R; 342/385

(57) ABSTRACT

Linear synchronous motors (LSM) propel rail vehicles with greater efficiency and less environmental impact than diesel locomotives. LSM engines may require a position signal to commutate the windings of the ISM. This disclosure describes systems and methods for accurate determination of vehicle position based on position information derived from inductive power received and acceleration of the vehicle. Another aspect of the systems/methods is to estimate vehicle position with GPS and/or RFID readings of tags external to the vehicle. These estimates may be used to identify faults in vehicle position measurement, update the determined vehicle position, and correct acceleration estimates.

### CROSS-REFERENCE TO RELATED APPLICATIONS

This application claims priority to U.S. patent application Ser. No. 61/593,132, filed on Jan. 31, 2012 which is hereby incorporated by reference in its entirety.

### FIELD

The present invention generally relates to systems and methods for inductive power transfer (IPT) to commutate a linear synchronous motor (LSM) for propelling a vehicle such as a train.

### BACKGROUND

In the railroad industry, one may consider using linear synchronous motors (LSM) to propel rail vehicles. An LSM provides the efficiency and environmental benefits of electric versus diesel locomotives. There is a need for reduced power on-board the vehicle to power brakes, control systems, heating, air-conditioning lighting and passenger convenience (“hotel” power) without relying upon a live third rail or overhead, catenary wires. There is a requirement to provide a position signal that can be used to commutate the windings of the LSM. There is a further need to determine the position of the vehicle more precisely on the track.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

In one embodiment, the invention provides a system for determining a position of a moving vehicle. The system comprises a plurality of receivers configured to receive inductive power from an inductive power source. The plurality of receivers is further configured to deliver electric power to a power storage unit. The system further comprises a controller configured to determine a position of the vehicle relative to a position of the inductive power source based on position information derived from the inductive power received at the plurality of receivers and based on acceleration of the vehicle.

In another embodiment, the invention provides a method of determining a position of a moving vehicle. The method comprises receiving at a plurality of receivers inductive power from an inductive power source. The method further comprises determining a position of the vehicle relative to a position of an inductive power source based on position information derived from the inductive power received at the plurality of receivers and based on acceleration of the vehicle.

In another embodiment, the invention provides a system for determining a position of a moving vehicle. The system comprises means for means for receiving at a plurality of receivers inductive power from an inductive power source. The system further comprises means for determining a position of the vehicle relative to a position of an inductive power source based on position information derived from the inductive power received at the plurality of receivers and based on acceleration of the vehicle.

### BRIEF DESCRIPTION OF THE DRAWINGS

FIG. 1 is a simplified illustration of a vehicle on a track powered by a linear synchronous motor with power inductively coupled to the vehicle. An on-board controller combines data from an inertial sensor along with measurements from the inductive power transfer (IPT) windings to determine position, which is communicated via a radio link to a wayside controller, which controls the three-phase linear synchronous motor (LSM) inverter and the single-phase inductive power transfer inverter.

FIG. 2. is a simplified illustration of the primary and secondary windings used for inductive power transfer.

FIG. 3 shows the fixed spatial relationship between the LSM and IPT primary windings.

FIG. 4 is a simplified schematic of the transfer of power by inductive coupling in order to power on-board devices.

FIG. 5 is a block diagram of the algorithm used to measure the phase angle of the vehicle relative to the IPT primary windings.

FIG. 6 is a block diagram of the 3rd order state estimator that is used to combine inertial measurements with phase measurements in order to derive estimates of vehicle position, velocity and motor phase angle.

FIG. 7. is a block diagram of the radio link used to transfer data from the on-board controller to the wayside controller where it is used to commutate the LSM inverter, control vehicle position and velocity and manage on-board battery voltage.

FIG. 8 is a simplified plan view of a track with LSM and IPT windings and RFID tags spaced intermittently along the track.

FIG. 9 is a graph showing exemplary errors associated with an inertial sensor such as an accelerometer as a function of frequency.

FIG. 10 is a Bode diagram plot of the response of the state estimator output Estimated Position to the two sensors: Measured Theta derived from the IPT windings, and the inertial sensor.

FIG. 11 is a flowchart depicting an exemplary process for determining the motion of a moving vehicle.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The following detailed description is directed to certain specific aspects of the disclosure. However, the disclosure may be embodied in a multitude of different ways, for example, as defined and covered by the claims. It should be apparent that the aspects herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Similarly, methods disclosed herein may be performed by one or more computer processors configured to execute instructions retrieved from a computer-readable storage medium. A computer-readable storage medium stores information, such as data or instructions, for some interval of time, such that the information may be read by a computer during that interval of time. Examples of computer-readable storage media are memory, such as random access memory (RAM), and storage, such as hard drives, optical discs, flash memory, floppy disks, magnetic tape, paper tape, and punch cards.

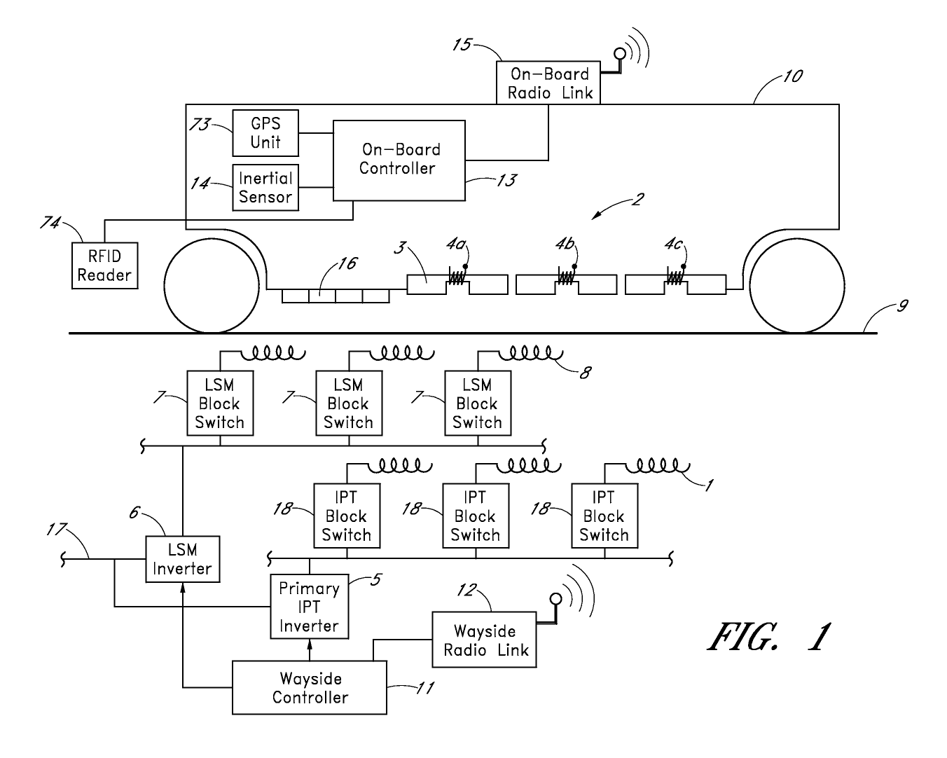

FIG. 1 is a simplified illustration of a vehicle 10 on a rail 9 (also referred to as a track 9) powered by a linear synchronous motor with power inductively coupled to the vehicle 10. Since the windings for the linear synchronous motor (LSM) 8 are fixed to the rail 9, the power to propel the vehicle 10 remains at the wayside. An on-board controller 13 may combine data from an inertial sensor 14 with measurements from the inductive power transfer (IPT) windings 1 to determine position, which may be communicated via a radio (e.g., RF) link 15 to a wayside controller 11, which controls the three-phase LSM inverter 6 and the single-phase inductive power transfer inverter 5. To communicate with a receiver (e.g., radio link 12), the radio link 15 may utilize any wireless communication link, such as a FM (VHF) link, a mobile/cellular network, a dedicated link or a public network such as the Internet, etc. In one embodiment, the inertial sensor 14 produces an output comprising three respective accelerometer components (or measurements) along the X, Y, and Z axes. Typically, the x-axis is a direction along the direction of travel of the vehicle (e.g., direction of track), the y-axis is a direction perpendicular to both the direction of travel of the vehicle and the direction of gravity, and the z-axis is a direction along the direction of gravity (e.g., vertical axis).

The vehicle 10 may be fitted with a periodic array of magnets 16 which may be a Halbach array. The magnet array may produce a magnetic flux pattern that is substantially directed below the vehicle 10 towards the rail 9. The flux pattern has characteristic spatial period with characteristic wavelength denoted by λ_{LSM}.

Inductive power transfer (IPT) provides a means to couple power from wayside of a rail 9 to a vehicle 10 without relying on a live third rail or overhead catenary wires. IPT may also be used as a means for wayside-to-train communication. A position signal may be derived from an analysis of the relative phase between inductively coupled secondary windings 4a, 4b, and 4c in order to determine the relative position between the vehicle 10 and primary windings 1 located on the rail 9. The position signal may be transmitted by a dedicated radio link 15 to wayside inverters that may be used to commutate a linear synchronous motor used for vehicle propulsion. The system may include wayside markers and/or a GPS sensor to provide additional information about the overall position of the vehicle in addition to the relative track-to-vehicle information that is provided by the inductive and inertial sensors.

In addition to providing a signal that may be used to commutate the LSM windings 8, there is a need to monitor the vehicle position on the rail 9 in order to selectively power only those sections of rail 9 that lie directly beneath the vehicle 10. The relative position signal derived from the IPT windings may only determine relative position within a single “wavelength” of the IPT windings. Some additional sensor may be used to determine a coarse position along the rail 9 that may be combined with the high-resolution signal determined from the IPT windings in order to unambiguously determine vehicle position.

Furthermore, there are sections of rail 9 where the primary IPT windings 1 may be interrupted. At track switches, for example, there may exist breaks in the windings where windings from one section terminate and windings for a new section of rail 9 begin. A system that relies exclusively on the IPT windings for position information may have difficulty crossing switches.

In one embodiment, the invention provides a means to derive relative position from the phase of the IPT secondary windings (4a, 4b, 4c) and to combine that relative position signal with additional sensors in order to provide a high-resolution position signal that is robust in the presence of anticipated errors. The invention further provides a reliable communication system that may be used to communicate position information from the vehicle 10 to the wayside controller 11. The invention further provides the ability to augment the relative position signal with additional position information that may unambiguously locate the vehicle 10 on the rail 9. The resulting position signal may be used to commutate windings of a linear synchronous motor 8 to propel the vehicle/train 10. The signal may also be used in part of a closed-loop position control scheme for the vehicle/train 10.

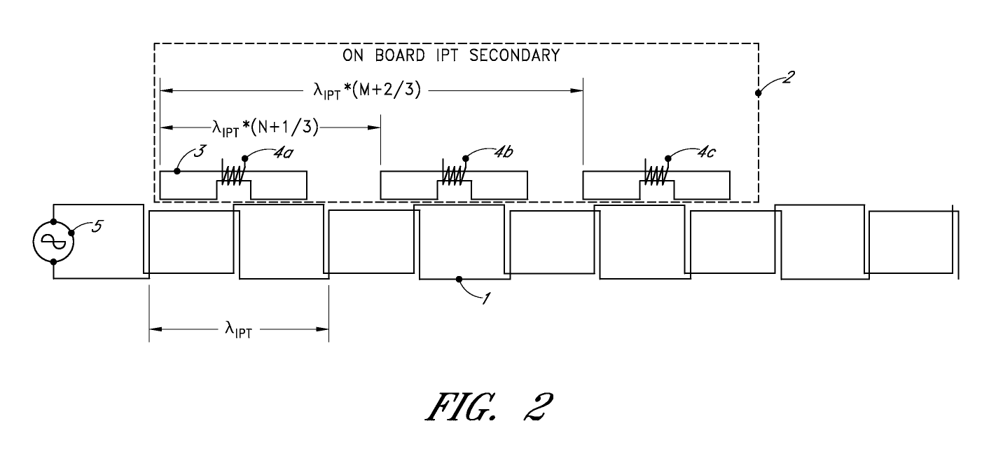

In one embodiment, a primary inductive power transfer (IPT) winding 1 may be located along the rail 9 in parallel with the linear synchronous motor (LSM) propulsion windings 8. The IPT winding 1 may lie beside the LSM winding 8. The primary winding 1 has a spatially distributed pattern in a fixed relationship to the LSM windings 8. The IPT primary 1 winding may comprise wires forming a figure-eight shape as shown in FIG. 2 where each loop of the figure eight may span a length substantially equal to the period of the LSM winding 8. Therefore, the complete figure-eight loop of the IPT primary winding 1 may span two wavelengths of the LSM winding 8.

The IPT windings 1 may repeat the figure-eight pattern continuously along the length of the rail 9. The IPT windings 1 may maintain a fixed spatial relationship to the LSM windings 8. The LSM windings 8 may be placed in a structure, such as a bobbin, that locates the LSM windings 8 in a predetermined spatial pattern. The same bobbin may be extended laterally (perpendicular to the axis of the track) with additional slots into which the IPT primary windings 1 may be placed. Thus, the bobbin may be used to maintain the necessary fixed spatial relationship between the LSM windings 8 and IPT primary windings 1.

Block switches 18 may connect sections of IPT windings 1 to a single-phase IPT inverter 5. The IPT windings 1 may lie beside the LSM windings 8 in the space between the rails of the rail 9.

The LSM windings 8 may be located along the rail 9. Each section of LSM winding 8 may be connected to a 3-phase inverter 6 by block switches 7. Only those sections of LSM winding 8 located beneath the vehicle 10 are powered at any one time. As the vehicle 10 moves along the rail 9, successive sections of LSM windings 8 are connected to the LSM inverter 6 as the vehicle 10 enters a section and disconnected as the vehicle 10 leaves a section. AC mains 17 provide power for the LSM inverter 6 and IPT inverter 5.

As described above, secondary windings (4a, 4b, 4c) are wound on ferrite cores 3 located on the vehicle 10. The ferrite cores may span one or more wavelengths of the IPT winding λ_{IPT}. On-board controller 13 may use relative phase voltages from the IPT secondary (4a, 4b, 4c) to determine position of the vehicle 10 relative to the rail 9. The controller 13 may combine data from an inertial sensor 14 with the data from the secondary windings 4a, 4b, and 4c to improve the precision of the position measurement. A GPS receiver 73 may be used to provide an initial position of the vehicle 10. An RFID tag reader 74 may provide redundant data that may be used to corroborate the position measurement derived from the GPS and position-sensing algorithm. An on-board radio link 15 may transmit position, velocity and phase angle data to a wayside radio link 12 that is connected to a wayside controller 11.

A wayside controller 11 may use data received from the vehicle/train 10 to control the LSM windings 8. The motor phase angle is used to commutate the three-phase LSM inverter 6. The position and velocity data may be used to close a position loop from which the current command to the LSM inverter 6 is derived.

A single-phase inverter 5 located at the wayside may be used to power the IPT primary windings 1. Switches 18 in the form of solid-state or mechanical relays may be used to selectively connect only a portion of the IPT primary winding 1 to the wayside inverter 5. A wayside control system 11 may determine which section of IPT winding 1 is to be powered at any time. The LSM controller may use a similar, three-phase inverter 6 and associated switches 7 to power only the section of LSM windings 8 that lie below the vehicle 10.

The IPT inverter 5 may drive the primary windings with an AC voltage. An AC frequency in the 20 kHz to 50 kHz range may be used in order to enhance the coupling of energy between the IPT primary 1 and on-board secondary windings 4a, 4b, 4c.

The secondary winding 4a, 4b, 4c may be formed as a polyphase winding with a spatial period that matches the IPT primary period. The polyphase winding may form a well-known three-phase winding. The secondary winding may include a ferrite core 3 or a core made of, for example, thin laminations of silicon steel in order to enhance magnetic coupling with the primary.

A demodulation circuit not shown may derive a relative position signal from the magnitude of the voltages on the polyphase windings. A three-phase secondary may produce 3 secondary voltages Vₐ, V_{b}, and V_{c}. The three secondary phase voltages may modulate in time at the primary AC frequency, and exhibit an amplitude envelope that may vary spatially with the relative position of the secondary winding relative to the primary winding. The three voltages may be processed to derive a position signal. The resulting position signal may vary from −π to π (radians) at twice the rate (one-half the period) of the primary winding wavelength. The primary wavelength may be selected to be substantially equal to twice the LSM wavelength. The derived position signal may therefore have the same period as the LSM windings and may be used to commutate the linear synchronous motor (LSM).

The signal derived from the IPT secondary windings 4a, 4b, 4c may invariably contain some undesirable higher harmonics due to imperfections in the winding geometry and/or non-linearity in the detection electronics. If not corrected, the higher harmonics may affect the motor commutation leading to vibration in the linear synchronous motor and a reduction in motor efficiency.

An inertial sensor 14 may be used to correct the errors in the inductive power IPT-derived position signal. As noted above, the inertial sensor 14 comprises a multi-axis accelerometer that may be located on the magnet array on the vehicle 10. In one embodiment, the accelerometer X-axis may be aligned with the fore-aft direction of the vehicle 10, the Y-axis may be aligned laterally and the Z-axis of the accelerometer may be aligned with the vertical axis. On level ground, the Z axis of the accelerometer may report 1G of acceleration while the X and Y axes should report 0 G (where “G” is the acceleration due to gravity or 9.806 meters/second²). The accelerometer output is integrated twice to produce a position signal. However, the accelerometer may invariably have some slight bias to the output signal that may produce a false indication of 0 G. When integrated twice, the position signal from the accelerometer may tend to increase (or decrease) continuously even when the vehicle 10 is at rest.

An on-board GPS system 73 may be used to provide an indication of the vehicle location on the rail 9 to a resolution of roughly 5 meters. There are instances where a GPS signal may be unavailable such as in a tunnel or in dense urban areas where building may block reliable reception by the GPS receiver 73.

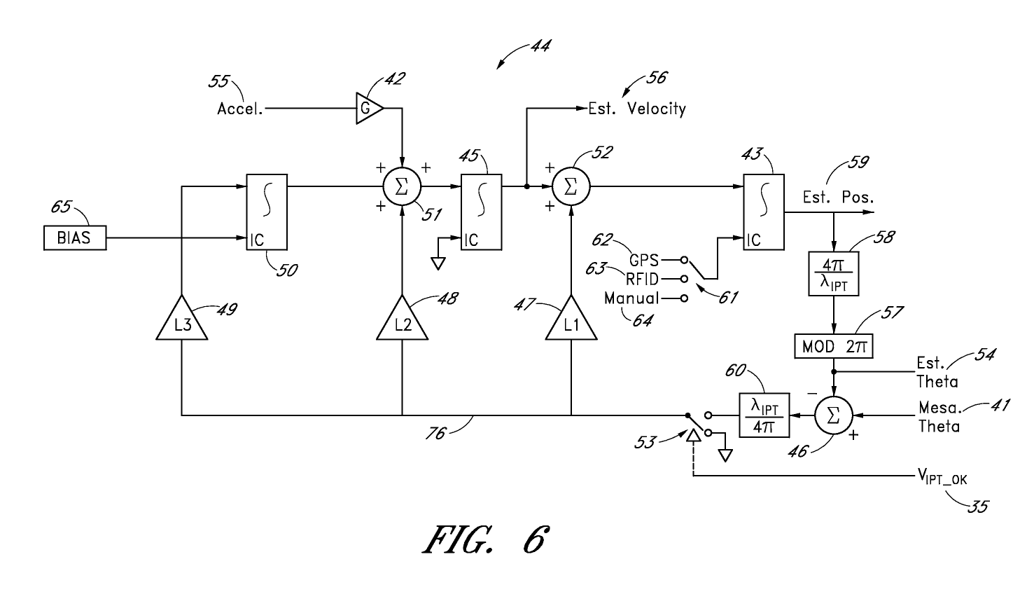

Wayside markers using RFID tags may be used as a redundant system to verify the location of vehicle 10. Passive RFID tags may be positioned at a pre-determined spacing along the rail 9: a unique tag every 50 meters, for example. As the vehicle 10 passes over the tag, a reader on the vehicle 10 may interrogate the tag and, based on the unique ID stored in the tag, the exact location of the vehicle may be found by looking up the tag location in a database of previously recorded tag locations. This should corroborate the location determined by the GPS 73 plus accumulated position from the state estimator as shown in FIG. 6. Some small deviation between tag position and computed position would be considered acceptable, but in the case of a discrepancy greater than a pre-determined limit, the vehicle 10 would be stopped while the source of discrepancy diagnosed.

In the case where a vehicle/train 10 started from a power off condition in an area without access to reliable GPS data, the vehicle/train 10 would be permitted to travel at a minimum speed for a pre-determined maximum distance until a RFID tag was detected or a GPS signal was received. If no tag was found or GPS signal received, the vehicle/train 10 would be stopped and the problem diagnosed.

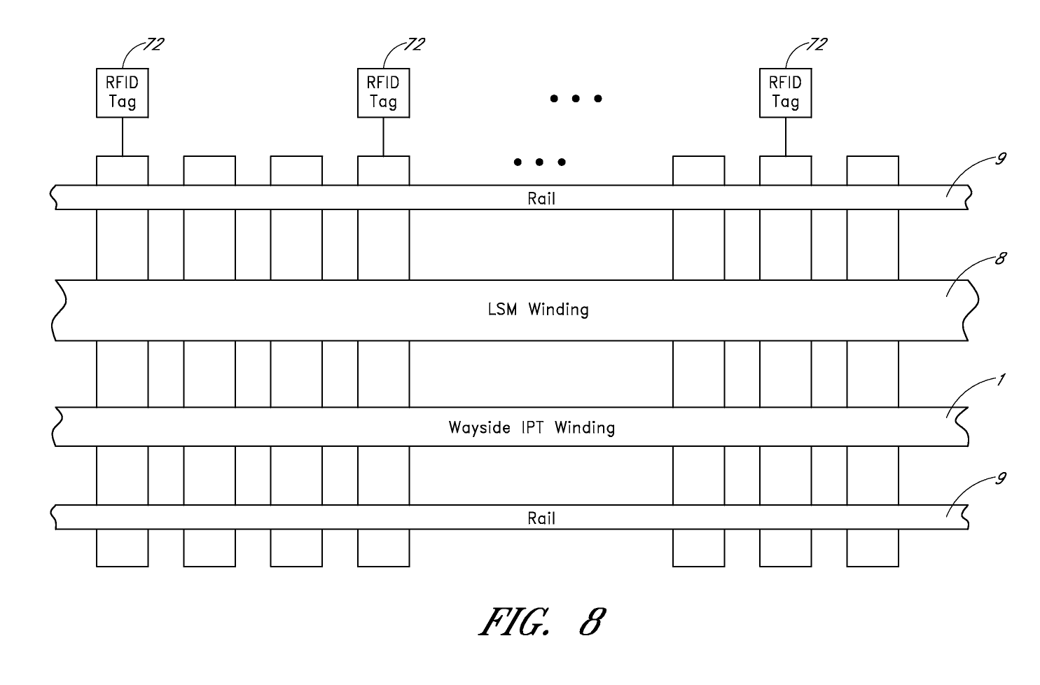

The invention provides redundancy provided by combing multiple sensors. Position derived by integrating an accelerometer may be used to ensure continuous position data even when the inductive power transfer (IPT) signal is momentarily interrupted. Multiple means exist to establish the initial position of the vehicle 10. Once the initial position is established, the position derived from a state estimator as shown in FIG. 6 may be compared with position derived from the RFID tags as shown in FIG. 8 and any significant discrepancy used to indicate a possible fault condition and bring the vehicle 10 to a safe stop.

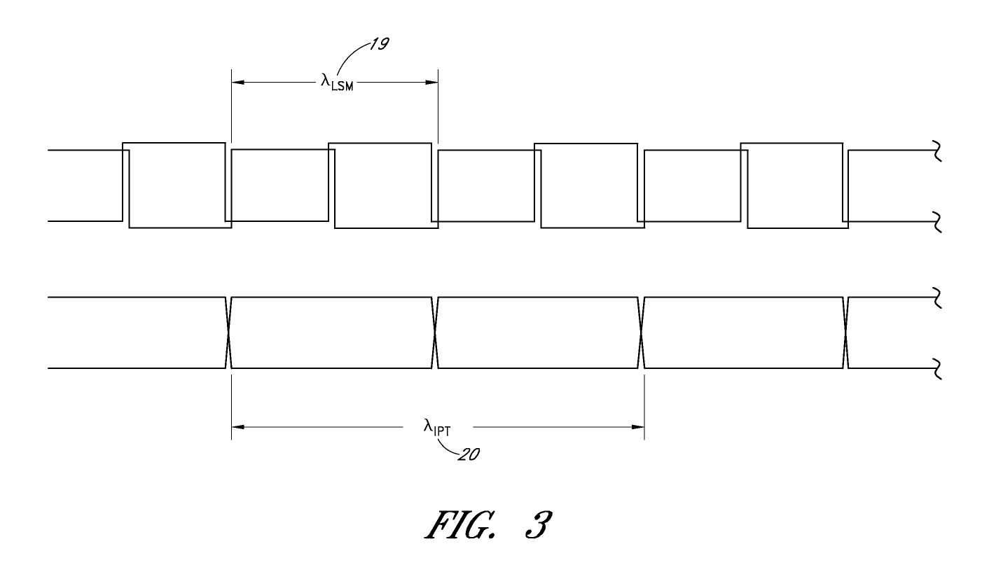

FIG. 2 is a simplified illustration of the IPT primary 1 and IPT secondary windings 4a, 4b, 4c used for inductive power transfer. The primary IPT winding 1 configured in a repeating figure-eight loop with a characteristic period of λ_{IPT} as shown in FIG. 3. The λ_{IPT} period may be selected to be substantially equal to twice the LSM period λ_{LSM}. The IPT secondary windings 4a, 4b, 4c are located on the vehicle as shown in FIG. 1. While an air core may be used for the secondary windings 4a, 4b, 4c, ferrite cores 3 may improve coupling of flux between the IPT primary 1 and therefore improve the efficiency of power transferred across the air gap. The IPT secondary 4a, 4b, 4c may be wound in a three-phase winding. Each phase may be wound on a ferrite core 3. Each core may span an integral number of IPT periods. The 3 ferrite cores are spaced an integer number of IPT periods apart, plus an additional ⅓ or ⅔ periods in order to create a well known three-phase winding. For example, winding 4b is spaced an integral number plus ⅓ periods from winding 4a. Winding 4c is spaced an integral plus ⅔ windings from winding 4a.

FIG. 3 shows the fixed spatial relationship between the LSM and IPT primary windings. The period of the IPT winding λ_{IPT} 20 may be selected to be substantially equal to twice the period of the LSM winding λ_{LSM} 19. The spatial relationship between the LSM and IPT windings may be controlled by winding both windings on a common bobbin whereby the desired phase relationship is maintained by the geometry of the bobbin.

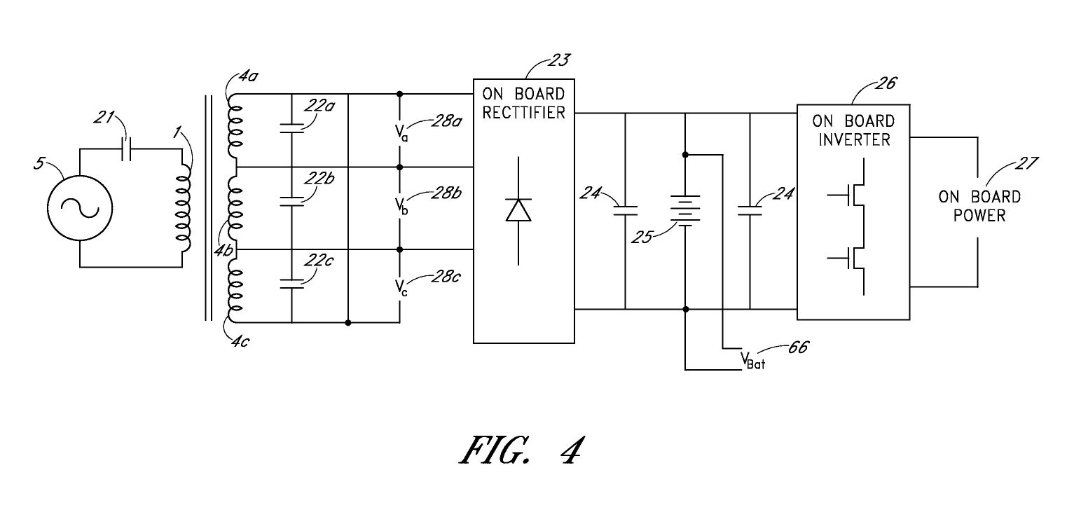

FIG. 4 is a simplified schematic of the transfer of power from the track to the vehicle by inductive coupling in order to power on-board devices. The IPT primary 1 may be powered by a single-phase inverter 5 that is tuned with a capacitor 21 to resonant at a desired frequency. The frequency may be in the range of 20 to 50 kHz. The IPT primary winding 1 may inductively couple to the polyphase secondary windings 4a, 4b, and 4c. The amount of coupling to the polyphase secondary 4a, 4b, and 4c is related to the relative position of the vehicle to the track. The relative magnitude of the AC voltage on the secondary windings 4a, 4b, and 4c, indicated as Vₐ 28a, V_{b} 28b and V_{c} 28c, is indicative of the relative position of the vehicle to the track.

Secondary tuning capacitors 22a, 22b and 22c tune the secondary to operate near resonance at the selected frequency of the IPT inverter 5. A three-phase polyphase rectifier 23 converts the secondary AC voltage 28a, 28b, and 28c to a DC voltage that is filtered by DC link capacitor(s) 24 and may be used to charge battery 25. The rectifier 23 on the vehicle may rectify the AC signal received on the secondary windings 4a, 4b, 4c and the resulting DC may be used to charge the on-board battery 25. On-board power 27 may be taken from the battery 25, possibly through an inverter 26 that converts the DC battery voltage 66 to an AC voltage compatible with on-board equipment.

The-board inverter 26 converts the DC battery voltage 66 into AC power that may be used to power on-board devices as needed. Note that during brief moments when the transfer of power by the IPT sub-system is interrupted, such as might happen at track switches, power may be maintained on-board by the battery 25. Thus on-board control systems, vehicle/train communication and similar sensitive devices are not affected by momentary disruptions in inductive power transfer.

The battery voltage 66 may be measured by the on-board controller 13 as shown in FIG. 1 and sent as part of the data packet to the wayside controller 11. The wayside controller 11 may use the voltage measurement in a closed loop controller to modulate the amplitude of voltage on the IPT primary winding 1 so as to maintain a desired state of charge in the on-board battery 25.

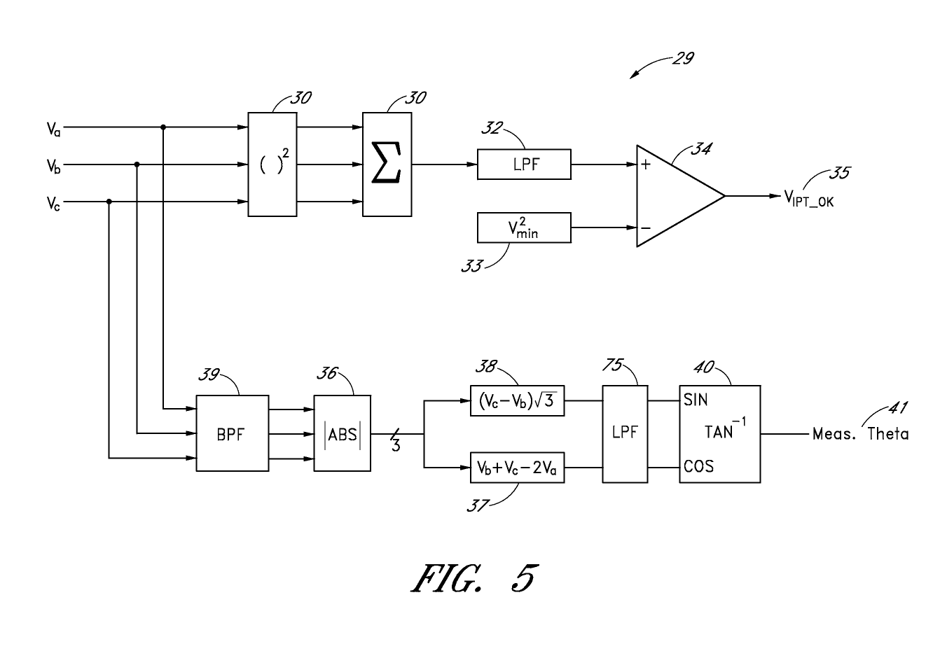

FIG. 5 is a block diagram of the algorithm used to measure the phase angle 41 of the vehicle relative to the IPT primary windings. The algorithm determines the phase relationship of the IPT secondary windings 4a, 4b, and 4c relative to the IPT primary 1. The 3 secondary voltages Vₐ, V_{b}, and V_{c} are squared by block 30 and summed by block 31 to produce a signal proportional to the instantaneous square of the secondary amplitude. Since the secondary is operating at a frequency preferably in the range of 20 to 50 kHz, the instantaneous output of summer 31 may vary between 0 and the square of the peak secondary voltages 28a, 28b, 28c as shown in FIG. 4. A low pass filter 32 filters the AC signal to produce a slowly varying signal proportional to the square of the secondary voltage. The secondary amplitude is compared in comparator 34 with a pre-determined minimum threshold voltage 33 in order to detect when the IPT system is momentarily disrupted. A signal V_{IPT}_{_{—}}_{OK} 35 may be used in the state estimator shown in FIG. 6 to momentarily ignore position feedback from the IPT windings when the IPT signal is disrupted. As seen from the equations below, the sum of the squares of Vₐ, V_{b}, and V_{c} is constant and each is proportional to a secondary voltage Vₛ (Note Vₐ, V_{b}, and V_{c} are shifted by 2π/3 with respect to one another):

$$\begin{matrix}{V}_{a} = {V}_{s} cos θ & ( 1 ) \\ {V}_{b} = {V}_{s} cos ( θ + α ) & ( 2 ) \\ {V}_{c} = {V}_{s} cos ( θ - α ) & ( 3 ) \\ α = \frac{2 π}{3} & ( 4 ) \\ {V}_{a}^{2} + {V}_{b}^{2} + {V}_{c}^{2} = {V}_{s}^{2} [ {cos}^{2} θ + {cos}^{2} ( θ + α ) + {cos}^{2} ( θ - α ) ] \\ {V}_{a}^{2} + {V}_{b}^{2} + {V}_{c}^{2} = {V}_{s}^{2} [ \begin{matrix}{cos}^{2} θ + {( cos θcosα - sin θsinα )}^{2} + \\ {( cos θcosα + sin θsinα )}^{2}\end{matrix} ] & ( 5 ) \\ cos α = - \frac{1}{2} & ( 6 ) \\ sin α = \frac{\sqrt{3}}{2} & ( 7 ) \\ {V}_{a}^{2} + {V}_{b}^{2} + {V}_{c}^{2} = {V}_{s}^{2} [ \begin{matrix}{cos}^{2} θ + {( - \frac{cos θ}{2} - \frac{\sqrt{3}}{2} sin θ )}^{2} + \\ {( - \frac{cos θ}{2} + \frac{\sqrt{3}}{2} sin θ )}^{2}\end{matrix} ] & ( 8 ) \\ {V}_{a}^{2} + {V}_{b}^{2} + {V}_{c}^{2} = [ \begin{matrix}{cos}^{2} θ + \frac{{cos}^{2} θ}{4} + \frac{\sqrt{3}}{2} cos θ sin θ + \frac{3 {sin}^{2} θ}{4} + \\ \frac{{cos}^{2} θ}{4} - \frac{\sqrt{3}}{2} cos θ sin θ + \frac{3 {sin}^{2} θ}{4}\end{matrix} ] & ( 9 ) \\ {V}_{a}^{2} + {V}_{b}^{2} + {V}_{c}^{2} = {V}_{s}^{2} [ \begin{matrix}{cos}^{2} θ + \frac{{cos}^{2} θ}{2} + \frac{\sqrt{3}}{2} cos \frac{3 {sin}^{2} θ}{4} + \frac{{cos}^{2} θ}{4} - \\ \frac{\sqrt{3}}{2} cos θ sin θ + \frac{3 {sin}^{2} θ}{4}\end{matrix} ] & ( 10 ) \\ {V}_{a}^{2} + {V}_{b}^{2} + {V}_{c}^{2} = {V}_{s}^{2} [ {cos}^{2} θ + \frac{{cos}^{2} θ}{2} + \frac{3 {sin}^{2} θ}{2} ] = \frac{3}{2} {V}_{s}^{2} [ {cos}^{2} θ + {sin}^{2} θ ] = \frac{3}{2} {V}_{s}^{2} & ( 11 ) \\ {V}_{a}^{2} + {V}_{b}^{2} + {V}_{c}^{2} = \frac{3}{2} {V}_{s}^{2} & ( 12 )\end{matrix}$$

The phase of the secondary relative to the primary may be derived by the algorithm shown in FIG. 5. Since the secondary voltages Vₐ, V_{b}, and V_{c} are AC signals, the normal polyphase relationship between voltages in a three-phase winding are modulated by the inductive power transfer (IPT) source frequency. In the absence of such modulation, the phase of the secondary relative to the primary may be determined by taking the 4-quadrant arctangent 40 of a “cosine” 37 and “sine” 38 signal. The three secondary voltages Vₐ, V_{b}, and V_{c} may be filtered in a narrow-band bandpass filter 39 to isolate the fundamental frequency and reject non-synchronous noise. The three secondary voltages pass through an absolute value circuit 36 in order to make a voltage with a non-zero average amplitude that is proportional to the phase-modulated AC signal amplitude. The cosine of the secondary voltages is formed in block 37 and the sine in block 38. However, the resulting phase measurement would be corrupted with each cycle of the AC frequency as the secondary voltages pass through zero volts. Low pass filter 75 filters out the high-frequency modulation of the signal to reveal the low-frequency phase information. The phase 41 is recovered by taking the four-quadrant arc-tangent 40 of the filtered sine 38 and cosine 37 signals. The result is a signal, Measured Theta 41 (Meas. Theta (θ)), that varies from −π it to π at twice the frequency (one half the spatial period) of the IPT winding period λ_{IPT} as shown in FIG. 2. Since λ_{IPT} was selected to be substantially equal to twice the linear synchronous motor (LSM) wavelength (λ_{LSM}), the resulting Measured Theta 41 signal is directly related to the phase of the LSM.

However, the Measured Theta 41 signal may invariably contain some phase distortion relative to the true phase of the LSM. The distortion is caused by imperfections in the physical location of the windings (geometrical errors), errors due to stray flux leakage from the LSM windings to the IPT secondary and distortions caused by the absolute value circuit 36 applied to the signal during the phase recovery processing 29. The absolute value circuit 36 alone produces a distortion at the 3rd harmonic of the fundamental period. If not corrected, these distortions may lead to vibrations in the LSM when used to commutate the motor and a loss in motor efficiency. The following equations show the phase angle recovery as demonstrated in FIG. 5 from the three phase voltages Vₐ, V_{b}, and V_{c}:

$$\begin{matrix}{V}_{c} - {V}_{b} = {V}_{s} [ cos ( θ - α ) - cos ( θ + α ) ] & ( 13 ) \\ {V}_{c} - {V}_{b} = {V}_{s} [ cos θ cos α + sin θ sin α - cos θ cos α + sin θ sin α ] & ( 14 ) \\ {V}_{c} - {V}_{b} = {V}_{s} 2 sin θ sin α & ( 15 ) \\ {V}_{c} - {V}_{b} = \sqrt{3} {V}_{s} sin θ & ( 16 ) \\ sin θ = \frac{{V}_{c} - {V}_{b}}{\sqrt{3} {V}_{s}} & ( 17 ) \\ 2 {V}_{a} - {V}_{b} - {V}_{c} = {V}_{s} [ 2 cos θ - cos ( θ + α ) - cos ( θ - α ) ] & ( 18 ) \\ 2 {V}_{a} - {V}_{b} - {V}_{c} = {V}_{s} [ \begin{matrix}2 cos θ - cos θ cos α + sin θ sin α - \\ cos 0 cos α + sin θ sin α\end{matrix} ] & ( 19 ) \\ 2 {V}_{a} - {V}_{b} - {V}_{c} = {V}_{s} [ 2 cos θ - 2 cos θ ( \frac{- 1}{2} ) ] & ( 20 ) \\ 2 {V}_{a} - {V}_{b} - {V}_{c} = 3 {V}_{s} cos θ & ( 21 ) \\ cos θ = \frac{2 {V}_{a} - {V}_{b} - {V}_{c}}{3 {V}_{s}} & ( 22 ) \\ θ = {tan}^{- 1} ( \frac{sin θ}{cos θ} ) = {tan}^{- 1} ( sin θ \frac{1}{cos θ} ) & ( 23 ) \\ θ = {tan}^{- 1} ( ( \frac{{V}_{c} - {V}_{b}}{\sqrt{3} {V}_{s}} ) ( \frac{3 {V}_{s}}{2 {V}_{a} - {V}_{b} - {V}_{c}} ) ) = {tan}^{- 1} ( \frac{\sqrt{3} ( {V}_{c} - {V}_{b} )}{2 {V}_{a} - {V}_{b} - {V}_{c}} ) & ( 24 )\end{matrix}$$

FIG. 6 is a block diagram of the 3rd order state estimator 44 that may be used to combine inertial measurements with phase measurements in order to derive estimates of vehicle position 59, velocity 56 and motor phase 54 angle. The position sensor may be improved by incorporating an inertial sensor with the phase measurement 41 calculated in FIG. 5 to derive an improved “estimate” of motor phase: Estimated Theta 54 (Est. Theta). A 3rd order state estimator 44 as shown in FIG. 6, may be used to optimally combine acceleration data 55 from an inertial sensor 14 with the position data (Measured Theta 41) recovered from the inductive power transfer (IPT) windings. In one embodiment, the acceleration data 55 is based on or derived from the x-axis component of the acceleration measurement provided by the inertial sensor 14. The 3rd order state estimator 44 is a dynamic system, implemented in a microprocessor or digital signal processor that produces “estimates” of position 59, velocity 56 and accelerometer bias 65. The resulting signals may be used in a feedback control law to perform closed loop control of the vehicle position. The state estimator 44 may produce a signal that is substantially free of distortions that may be used for motor commutation in addition to position 59 and velocity 56 signals that indicate the current state of the vehicle/train.

The signal from the inertial sensor 55 may be integrated once to produce a velocity signal (Estimated (Est.) Velocity 56) and a second time to produce a position signal (Estimated Position (Est. Pos.) 59). However, any bias on the inertial signal 55 would lead to an ever-increasing error that would rapidly degrade the utility of the state estimates. The state estimator 44 corrects for this error by comparing the state estimate of position 59 with the position measurement derived from the IPT windings and applying feedback in such a way that the inertially-derived position is driven to converge to the IPT-derived position measurement. Feedback gains L₁ 47, L₂ 48 and L₃ 49 may be used to set the dynamic response of the state estimator 44 and thereby establish a frequency below which the position recovered from the IPT windings 41 dominates the response and above which the twice-integrated inertial sensor position 59 dominates the response.

The inertial measurement 55 may be scaled in gain block 42 to appropriate units. The acceleration signal is integrated to produce a velocity estimate 56 in integrator 45. The velocity signal is integrated again in integrator 43 to produce the Estimated Position signal 59. The initial condition on the position integrator 43 is selected from switch 61 to come from either of three sources: a GPS-derived initial position 62, an initial position derived from an RFID tag 63 or possibly from an initial position set manually by the vehicle operator 64. Note that the initial position may be only applied when the state estimator 44 is first turned on. Once started, the state estimator 44 may rapidly force the Estimated Position 59 signal to conform to the phase measurement signal 41.

The Estimated Position signal 59 may have linear units such as meters that are useful for performing closed loop speed or position control of the vehicle/train. The Estimated Position signal 59 may be converted into units of motor phase in order to compare with the Measured Theta signal 41 derived from the IPT windings. Gain block 58 converts the linear position units of Estimated Position signal 59 to equivalent motor phase angle in radians. The phase signal is converted to the range of −π to π by taking the modulo(2π) in block 57 of the phase signal. The resulting Estimated Theta 54 is compared with the Measured Theta 41 signal from the IPT detection circuit in summer 47 and the resulting error, when scaled to appropriate linear units in gain block 60, is used to drive the Estimated Position 59 signal into convergence.

In normal operation switch 53 may connect the estimator error signal 76 to the feedback gains L₁ 47, L₂ 48 and L₃ 49. However, during instants when the IPT signal is not available, the V_{IPT}_{_{—}}_{OK} signal 35 may momentarily hold the state estimator error signal 76 at 0 and therefore not allow erroneous Measured Theta 41 measurements to corrupt the state estimates of position 59 and velocity 56.

Feedback gains L₁-L₃ (47-49) force the state estimates to converge to values that are consistent with the phase measurements 41 derived from the IPT windings. Feedback gain L₃ may be applied to the state estimator error 76 and integrated in bias integrator 50 and summed with the acceleration measurement 55 in summer 51. An initial estimate of acceleration bias in block 65 may be used to reduce the time it takes the state estimator 44 to converge to the correct bias when first turned on. Over time, however, the inertial sensor bias 65 may drift. Bias integrator 50 may track the bias 65 in order to maintain convergence between the Estimated Theta 54 and Measured Theta 41 signals. The bias integrator 50 integrates the state estimator error signal 76 and therefore may only converge to a stable estimate of accelerometer bias 65 when the state estimator error 76 is zero mean. This ensures that the difference between Estimated Theta 54 and Measured Theta 41 is zero mean.

The feedback gains L₁ 47, L₂ 48 and L₃ 49 may be selected to achieve a desired dynamic response in the state estimator 44. The dynamic response may be determined by considering the types of errors that are present on the two sensors that are available: the inertial sensor and the position signal derived from the IPT windings. The IPT windings produce a reliable estimate of motor phase, but may also contain error sources at higher frequencies. The inertial sensor 14 (see FIG. 1), when twice integrated, produces an extremely accurate indication of position, but is prone to drift at low frequencies. The state estimator 44 combines the two signals to extract the best information from both: low frequency data from the IPT windings corrects for drift of the inertial sensor while the inertial sensor provides a position signal that is free from harmonic errors.

The state estimator may also be simplified using Laplace Transforms, in which case the integrator blocks 50, 45, and 43 may be represented as 1/s (“s” is the result of applying the Laplace Transform to convert a differential equation to an algebraic equation). In this simplification, the state controller may be represented as the following relationship between the gains L₁-L₃ (47-49) and the response of estimated position 59 to each of the two inputs that drive the response: Measured Theta and Acceleration.

$$\begin{matrix}\frac{y}{Acceleration} = \frac{s}{{s}^{3} + {L}_{1} {s}^{2} + {L}_{2} s + {L}_{3}} & ( 25 ) \\ \frac{y}{MeasuredTheta} = \frac{{L}_{1} {s}^{2} + {L}_{2} s + {L}_{3}}{{s}^{3} + {L}_{1} {s}^{2} + {L}_{2} s + {L}_{3}} & ( 26 )\end{matrix}$$

The two transfer functions can be plotted as a Bode diagram with consistent units if Inertial Position is used instead of Acceleration. Inertial Position is the second integral of Acceleration, or equivalently, Acceleration can be considered as the 2nd derivative of Inertial Position.

$$InertialPosition = \frac{1}{{s}^{2}} Acceleration \qquad ( 27 )$$

The transfer function of estimate position (y) to Inertial Position is therefore:

$$\frac{y}{Inertial Position} = \frac{y}{Acceleration} {s}^{2} = \frac{{s}^{3}}{{s}^{3} + {L}_{1} {s}^{2} + {L}_{2} s + {L}_{3}} \qquad ( 28 )$$

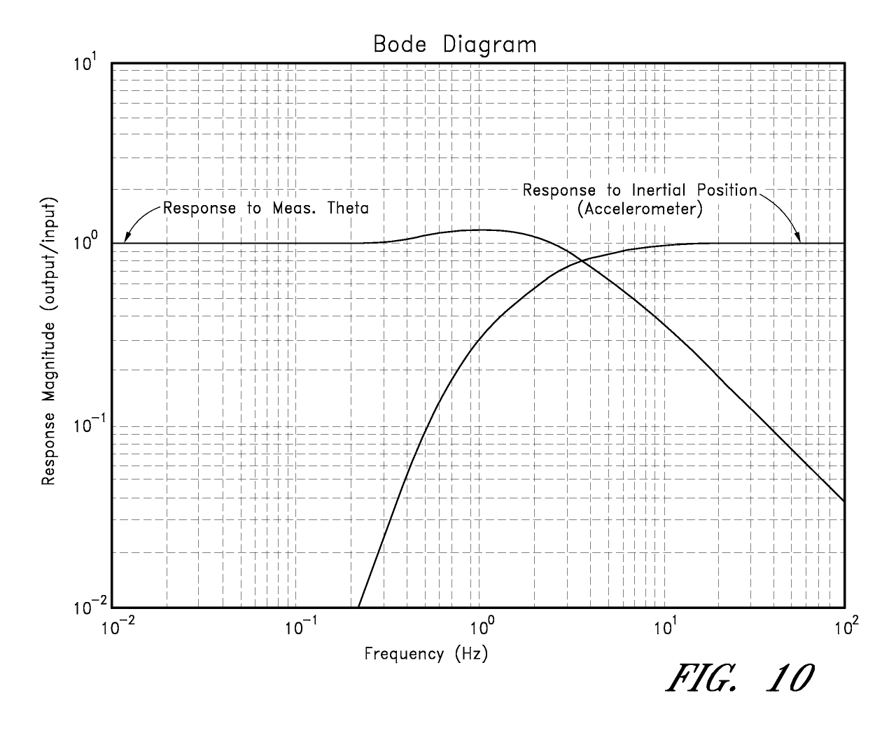

The two transfer functions (Estimated Position/Measured Theta and Estimated Position/Inertial Position) are shown in a Bode diagram as FIG. 10. The Bode diagram shows the role of Measured Theta driving the response at low frequency and the inertial signal driving response at high frequency. The state estimator bandwidth determines the transition frequency. For example, thee gain blocks 47-49 may be set to achieve a desired bandwidth in order to achieve a well-damped response. For example, L₁=3.75 ωₙ, L₂=3 ωₙ², and L₃=ωₙ³ wherein ω=2πf and f=frequency (Bandwidth).

One may initially seek to use the accelerometer signal alone and dispense with the IPT-derived position signal. The accelerometer drift would become significant if it were not for the feedback provided by the state estimator 44 that forces the convergence between the twice-integrated accelerometer signal shown by estimated position 59 with the IPT-derived position signal 41. Once the state estimator 44 corrects the drift of the accelerometer, the accelerometer may be used to provide a signal of remarkably high resolution. The resolution limit is constrained by the electrical noise of the accelerometer and the bandwidth of the state estimator 44. For example, a typical low cost accelerometer might exhibit wide-band noise in the range of 100 □G/root-Hertz or about 0.001 M/sec2/root-Hertz. When integrated in a state estimator with a bandwidth of 1 Hertz, the resulting position signal may have an error due to accelerometer noise of roughly 15 microns (1-sigma). At higher frequencies, the error from the accelerometer becomes even smaller. Since the function of the position signal is to commutate the linear synchronous motor (LSM) and provide position information about the vehicle, precision significantly less than about 1% of the motor wavelength is not significant. For typical motor wavelengths in the range of 0.2 meter to 1 meter, a practical limit to useable resolution is approximately 2 to 10 millimeter. This translates into a 1-sigma specification of approximately 300 to 1500 microns. Lowering the state estimator bandwidth so as to use the (error-free) accelerometer at even lower frequencies may increase the position error due to accelerometer noise. At an estimator bandwidth of 0.133 Hz, the accelerometer noise would equal 300 microns (1-sigma). A bandwidth of 0.133 Hz corresponds to a temporal period of 7.5 seconds. In other words, the accelerometer signal may be used to provide position information sufficient for motor commutation when the drift is corrected by comparing with some other position sensor at no more than once every 7.5 seconds. At a vehicle speed of 25 meters/sec (approximately 55 MPH), the vehicle travels 187 meters in 7.5 seconds.

The output of the state estimator 44 may be transmitted to the wayside controller shown in FIG. 1, where it may be used to commutate the LSM windings, using a radio link. There are a number of commercially available radio communication protocols that may be considered for this application. The radio link may exhibit low and deterministic latency. Latency is the time between when the position signal is available to be transmitted and when the wayside controller receives it. For typical radio communication protocols, the actual bit transmission rate is often more than adequate. The latency usually occurs due to protocol overhead in the transmitter or receiver. There exist other requirements for vehicle/train-to-track bi-directional communication to handle voice, vehicle/train status and safety-related information. Since this data does not have the same stringent latency requirements as the position information used for motor commutation, the position signal may be sent using a dedicated radio link as shown in FIG. 1 with a protocol optimized for low and deterministic latency while a separate radio link is used for all other vehicle/train communication.

The position signal provided by the state estimator 44 may be used to determine the relative position (phase) between the armature and stator of the LSM sufficient for the purpose of motor commutation. However, it does not indicate where the vehicle is along the track. The problem is that the state estimator output is simultaneously very accurate and very “uncertain”. The uncertainty is due to the fact that the LSM windings are periodic and there is nothing to identify which motor period the vehicle is aligned with. GPS and RFID data as shown in FIG. 1 may be used to provide additional information on vehicle location.

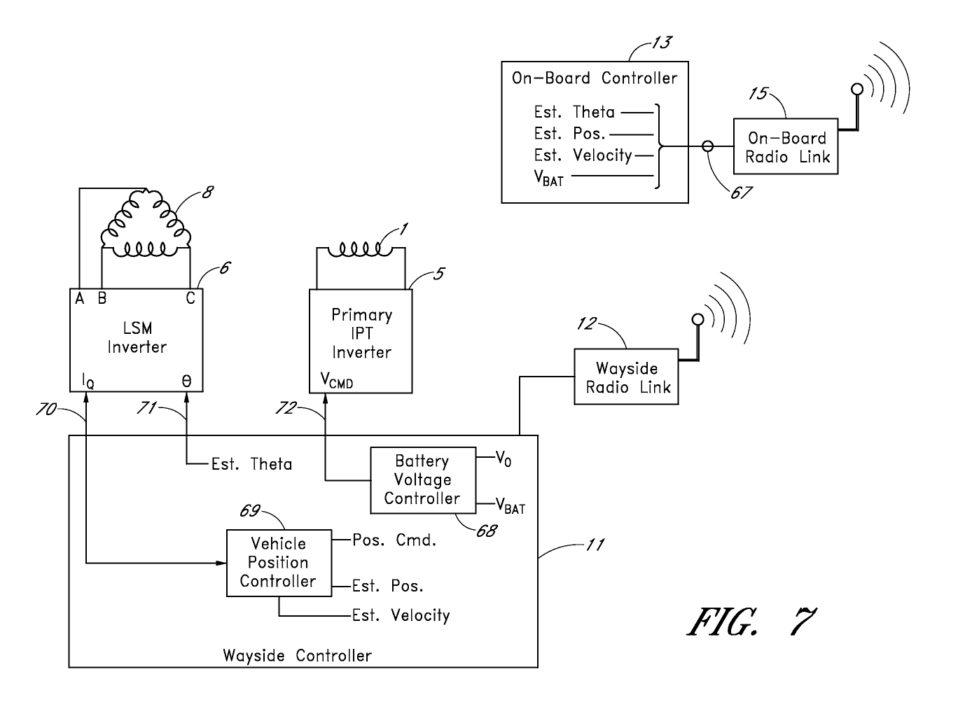

FIG. 7 is a block diagram of the radio link 15 used to transfer data from the on-board controller 13 to the wayside controller 11. The wayside controller 11 may be used to commutate the LSM inverter 6, control vehicle position and velocity by block 69 and manage on-board battery voltage. The state of the vehicle, Estimated Position, Estimated Velocity and Estimated Theta as shown in FIG. 6 as well as the state of charge of the battery, V_{bat}, as shown in FIG. 4 are formed into a data packet 67 and sent to the wayside controller 11 using a dedicated radio link 15 and 12. The wayside controller 11 compares the V_{bat} signal with a desired reference voltage for the battery and alters the amplitude of the inductive power transfer (IPT) inverter 5 and the resulting voltage amplitude on the IPT primary windings 1.

The wayside controller 11 implements a position control loop 69 to control the thrust of the linear synchronous motor (LSM). The output of the position control loop 69 is a signal 70 that may be used to drive the current command to the LSM inverter 6. Along with the current command 70, the wayside controller 11 may supply a phase angle 71 based on the Estimated Theta signal received from the on-board controller 13 via the radio transmitter 15 and receiver 12.

There may be some latency between the measurement of Estimated Theta produced by the state estimator as shown in FIG. 6 in the on-board controller 11 and the application of the phase signal 71 to the LSM inverter 6. As the latency becomes large relative to the frequency of the LSM inverter 6 (which is set by the vehicle speed divided by the motor pitch λLSM), an error in motor commutation may be introduced that may degrade motor performance and lead to a periodic ripple in thrust. At certain frequencies, corresponding to certain vehicle speeds, the ripple thrust may produce uncomfortable vibrations in the vehicle. If the latency of the Estimated Theta signal is constant and known, then the wayside controller 11 may adjust the Estimated Theta to account for the time delay. Therefore, it may be desirable to implement a radio link 15 with low and deterministic latency. At a vehicle speed of 50 M/sec (109 MPH) and a motor wavelength of 0.5 M, the LSM inverter frequency may be 100 Hertz (period of 0.01 seconds). To maintain a commutation error of 1% or less, the uncertainty in latency would need to be less than 1% of 0.01 seconds or less than 100 microseconds. Note that the actual latency may be larger than this limit, but the variance in the latency must be kept small and hence deterministic. Dedicating a radio link 15 to the task, and thereby avoiding conflicts with traffic on the communications link that does not require such deterministic performance, may permit this performance to be achieved.

In order to perform position control of the vehicle, the absolute position (or “global” position) of the vehicle must be known. The measurement derived from the IPT windings and inertial sensor gives a very precise measure of position within one period of the LSM. However, since the LSM winding is a repetitive pattern, it alone cannot indicate where along the track the vehicle is located. A Global Positioning System (GPS) receiver as shown in FIG. 1 may be used to give an approximate location of the vehicle. The error from the GPS is approximately 5 meters. The state estimator may force the GPS initialized error to converge to a precise phase of the LSM winding, but there may be an error of an integer number of windings due to the uncertainty in the initial GPS signal. For many vehicle/train operations, this error may be insignificant. However, for stopping at a vehicle/train platform to allow passengers to get on and off, an error of 5 meters may be intolerable. Also, if the vehicle is to be used in an automated freight terminal then more accurate knowledge of position may be required.

FIG. 8 is a simplified plan view of a track with LSM 8 and IPT windings 1 and RFID tags 72 spaced intermittently along the rail 9. Radio Frequency Identification Tags 72 (RFID) may be used to improve the position estimate of the vehicle/train. RF tags may be located at discrete locations along the rail 9. Each tag 72 may contain a unique ID code and the precise location of each tag 72 may be recorded in a database that is available to the on-board controller as shown in FIG. 1. As the vehicle passes over the tag 72, a reader 74 located on the vehicle as shown in FIG. 1 may read the tag 72 and compare the recorded position for the tag with the Estimated Position signal 59 shown in FIG. 6. The difference may be used to determine an integer number of LSM periods (λ_{LSM}) as shown in FIG. 2 that may be applied to the Estimated Position signal 59 in order to determine the true position of the vehicle. Note that because the state estimator shown in FIG. 6 ensures that Estimated Position is synchronized to the LSM windings 8, the only possible error in Estimated Position may be an integral number of motor pitches. The RFID tag position may be used to resolve the uncertainty. The tag 72 locations along the rail 9 may be located at a fixed relationship to the LSM winding 8. Therefore the tag 72 locations stored in the database, when converted to motor phase, modulo(2π), may be a constant. Tag 72 locations may be placed at random locations with respect to LSM windings 8 as long as the tag 72 locations recorded in the database accurately reflect the true position of the tags. The tag 72 position only needs to be sufficiently accurate to resolve the vehicle position to the nearest wavelength of the LSM. An error of ¼ of a wavelength is sufficient to unambiguously resolve the vehicle position. Once a correction for the integer number of wavelengths is made, the Estimated Position signal may be accurate to the precision of the Measured Theta signal as shown in FIG. 5 derived from the IPT windings.

The RFID tags 72 may provide a redundant indication of vehicle position. As each tag 72 is crossed, the tag location may be extracted from the on-board database of tag locations and compared with the Estimated Position signal derived from the IPT windings. Once the initial uncertainty in position is resolved, subsequent RFID tags 72 should agree with the Estimated Position signal to within a small tolerance. If a position difference larger than a pre-determined threshold is detected, the vehicle may be brought to a stop and the discrepancy diagnosed.

In certain locations a GPS signal as shown in FIG. 1 may not be available with which to establish the initial position of the vehicle. If an RFID tag 72 is within range of the tag reader, then the initial position may be established using the tag location. In the event a tag is not near the vehicle, the initial position may be set by manually entering the known position in the state estimator as shown in FIG. 6. Once the rough position of the vehicle is known and communicated to the wayside controller, the wayside controller may energize the IPT windings beneath the vehicle. Once the IPT signal is received, the phase relationship of the vehicle to the track may be established which may allow the motor to be commutated correctly. After the vehicle starts moving, it may cross over an RFID tag 72, which may allow any remaining ambiguity in vehicle position to be resolved.

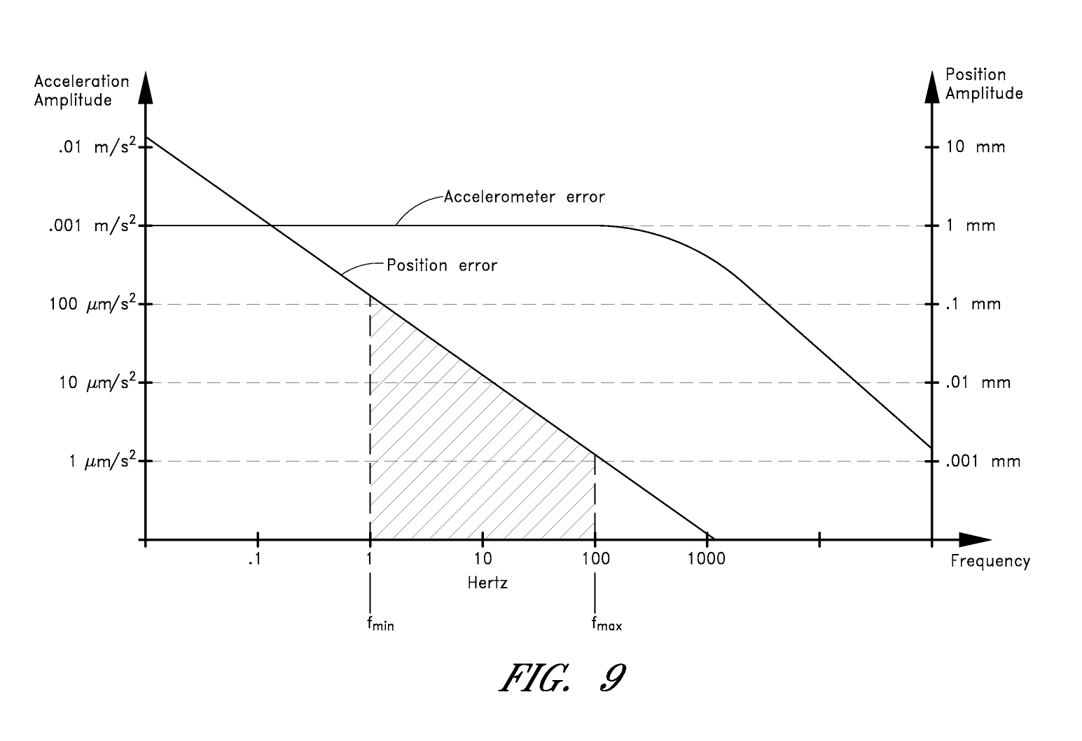

FIG. 9 is a graph showing exemplary errors associated with an inertial sensor such as an accelerometer revealing the merits of using an inertial sensor for position sensing. The figure is a logarithmic plot of acceleration versus frequency. Accelerometer error (actually the power spectral density of accelerometer noise) is plotted as a flat line at low frequency that falls off at higher frequency as the bandwidth of the inertial sensor is ultimately limited due to physical and electrical constraints. Many accelerometers exhibit errors that are relatively constant with frequency up to the bandwidth of the device. The second line on the plot shows the result of twice integrating the acceleration error signal. Integrating twice effectively divides the accelerometer error by the square of the frequency. This means that as long as the radian frequency (2π*frequency) is greater than 1, then the resulting position error may be numerically less than the acceleration error. At radian frequencies less than 1, the error in position may be numerically larger than the accelerometer error. A radian frequency of 1 corresponds to a frequency of ½π or 0.16 Hertz.

The total error that is produced by double integration of an accelerometer is found by integrating the noise density plot over a range of frequencies. The shaded area of FIG. 9 indicates the region over which the position error density signal is integrated in order to come up with a single number indicative of the overall root mean square (RMS) error due to the inertial sensor. The error derived by double integration becomes infinite at 0 frequency where one may establish a minimum frequency above which the position signal may be used. The bandwidth of the state estimator as shown in FIG. 6, determined by gains L₁-L₃, sets the effective lower frequency above which the position estimate is determined by double integration of the acceleration signal. The upper limit of frequency has only a minor influence on the overall position error due to the rapid decrease in position error with frequency.

As an example, an accelerometer noise density of 0.001 meters/second²/square_root(Hz), when twice integrated over the range in frequency from 1 Hertz to 100 Hertz, produces an RMS error in position of approximately 15 microns (less than 0.001 inches). Therefore, an accelerometer may be used to produce a very high-quality position signal as long as a means exists to remove the drift caused by bias. The state estimator provides the means to correct for accelerometer bias drift by forcing convergence between Estimated Theta and Measured Theta at low frequency. At frequencies above the state estimator bandwidth, the double integration of acceleration dominates the response. The limited bandwidth of the state estimator does not permit the high frequency errors of the IPT-derived phase measurement to corrupt the Estimated Theta signal that is sent to the wayside controller and used to commutate the linear synchronous motor (LSM).

FIG. 10 is a Bode diagram plot of the state estimator output (Estimated Position 59 as shown in FIG. 6) to the two sensors: Measured Theta 41 derived from the inductive power transfer (IPT) windings, and the inertial sensor 14. The state estimator output follows the Measured Theta 41 input at low frequencies, but the response falls off rapidly at frequencies above the bandwidth of the state estimator. At frequencies above the state estimator bandwidth, the state estimator output is dominated by the accelerometer measurement.

The “Accelerometer” response in FIG. 10 is the response to “inertial position” which is the double integration of acceleration. Since Measured Theta 41 and Acceleration have different units (position versus acceleration), it is difficult to visualize the effect of the state estimator bandwidth on the response. However, by plotting the response to inertial position rather than acceleration, the transfer functions have comparable units and can be plotted on the same axes.

The vertical axis is the ratio of the response (estimated position) to the input: either Measured Theta or the 2nd integral of acceleration (Inertial Position). The horizontal axis is frequency (in Hertz). Both the horizontal and vertical axes are logarithmic in order to show the large change in magnitude of response over a large range in frequency. The vertical scale covers the range from 1/100 to 10 (10⁻² to 10¹). Unity response (output equal to input) is indicated by 10°=1. The horizontal axis covers a range in frequency from 1/100 Hz to 100 Hz (10⁻² to 10²).

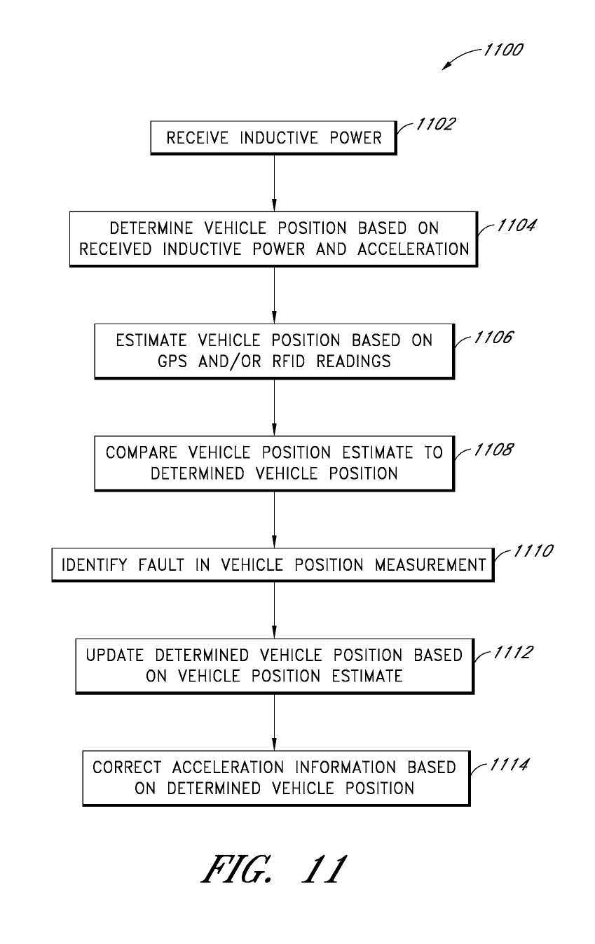

FIG. 11 is a flowchart of an exemplary process for determining a position of a moving vehicle. Block 1102 depicts the step of receiving at a plurality of receivers inductive power from an inductive power source. Block 1104 depicts the step of determining a position of the vehicle relative to a position of the inductive power source. This determination of position is based on position information derived from the inductive power received at the plurality of receivers and based on acceleration of the vehicle. Block 1106 depicts the step of estimating a vehicle position from at least one of a GPS receiver and an RFID reader, the RFID reader configured to read one or more markers located outside the vehicle. Block 1108 depicts the step of comparing the vehicle position estimate to the position determined from at least one of the inductive power received at the plurality of receivers and the acceleration of the vehicle. Block 1110 depicts the step of identifying a fault in measurement of the position of the vehicle based on the comparison of the vehicle position estimate to the position determined from at least one of the inductive power received at the plurality of receivers and the acceleration of the vehicle. Block 1112 depicts the step of updating the vehicle position based on the estimate of vehicle position. Block 1114 depicts the step of correcting an error in the information about the acceleration of the vehicle based the position determined of the vehicle. Other exemplary processes may omit or add one or more of steps 1102-1114, or operate in a different order.

It is understood that one skilled in the art may recognize variations to the description of the invention based on this disclosure. For instance, the invention may provide a closed-loop inverter (incorporating position feedback to control motor commutation) that will permit a more efficient operation of the motor. The invention may also provide for on-board power for brakes, train-to-track communication and have energy available for future installation of operator comforts such as lights and air conditioning. The proposed scheme will combine, in a single set of auxiliary windings that lie adjacent to the main propulsion windings, a means of inductively coupling power to the vehicle while simultaneously deriving a position signal that can be used to commutate the linear motor. The position-sensing scheme will make use of an on-board inertial sensor that, when combined with information derived from the IPT windings will provide a position signal that is extremely accurate and exhibits high tolerance to various forms of errors that can limit the accuracy of traditional inductive position sensing schemes. The position-sensing method, unlike other inertial position sensing methods, is accurate even at standstill and therefore can be used as a control signal for closed loop position control of the vehicle. Position control of the vehicle may allow for increased throughput in load and unload operations in a freight terminal compared to traditional, speed-control methods. In one embodiment, it may be desirable to adapt a commercial radio link to use to communicate position data to the wayside inverters. While it is possible to use the IPT windings, or similar windings, to provide bi-directional train-to-track communication, it may be desirable to use commercially available radio technology to perform this communication. The proposed position-sensing scheme has a requirement for low-latency and highly deterministic communication from the train to the LSM inverters. In one embodiment, it may be practical to implement a custom protocol on a commercially available radio frequency specifically for communicating position information to the inverter cabinet for the purpose of motor commutation. This link would be in parallel with any existing train-to-track communication scheme used for normal train status and control.

Appendix A is attached to provide a comprehensive list of components or items mentioned in the accompanying drawings.

### APPENDIX A

### Item Description

1 Wayside IPT winding
2 On-board IPT Secondary
3 Secondary core
4a Secondary winding, Phase a
4b Secondary winding, Phase b
4c Secondary winding, Phase c
5 IPT Inverter, Primary
6 LSM Inverter
7 LSM Block switch
8 LSM Winding
9 Rail
10 Vehicle
11 Wayside controller
12 Wayside radio link
13 On-board controller
14 Inertial sensor
15 On-board radio link
16 Magnet array
17 Grid power
18 IPT Block switch
19 LSM Wavelength
20 IPT Wavelength
21 Primary Tuning Capacitor
22a Secondary Tuning capacitor, phase a
22b Secondary Tuning capacitor, phase b
22c Secondary Tuning capacitor, phase c
23 Rectifier, On-board
24 DC Link Capacitors
25 Battery
26 Inverter, on-board
27 “hotel” power, on-board
28a Secondary voltage, phase a
28b Secondary voltage, phase b
28c Secondary voltage, phase c
29 Voltage monitor circuit
30 Square function
31 summation block
32 low pass filter
33 Minimum V-squared
34 Comparator
35 Voltage OK signal
36 Absolute value function
37 “Cosine” Phase
38 “Sine” Phase
39 Narrow-band bandpass filter
40 4 quadrant arc-tangent
41 Phase measurement
42 Accelerometer scale factor
43 Estimated (Est.) Theta Integrator
44 State Estimator
45 Estimated (Est.) Velocity integrator
46 Summer, observer error
47 Feedback gain, L₁
48 Feedback gain, L₂
49 Feedback gain, L₃
50 Acceleration bias integrator
51 Summer, acceleration
52 Summer, Velocity
53 Switch, Observer error
54 Estimated (Est.) Phase signal
55 Acceleration measurement
56 Estimated (Est.) Velocity signal
57 Modulo 2π
58 Scale: Convert linear position to phase
59 Estimated Position (Est. Pos.) signal
60 Scale: convert phase to linear units
61 Initial position select
62 Initial position from GPS
63 Initial position from RFID tag
64 Initial position entered manually
65 Initial estimate of accelerometer bias
66 Battery voltage measurement
67 Data packet sent to wayside controller
68 Controller, Battery voltage
69 Controller, Vehicle position
70 Current command to LSM inverter
71 Phase angle to LSM inverter
72 RFID tag
73 GPS Unit
74 RFID Reader
75 low pass filter
76 State estimator error signal

What is claimed is:

1. A system for determining a position of a moving vehicle, the system comprising:
a plurality of receivers configured to receive inductive power from an inductive power source, the plurality of receivers being further configured to deliver electric power to a power storage unit; and
a controller configured to determine a position of the vehicle relative to a position of the inductive power source based on position information derived from the inductive power received at the plurality of receivers and based on acceleration of the vehicle.

2. The system of claim 1, wherein each of the plurality of receivers comprises secondary windings and wherein the inductive power source comprises primary windings configured to transfer the inductive power to the secondary windings.

3. The system of claim 1, wherein the inductive power source comprises a plurality of windings connected to an AC power source separated by at least a plurality of switches that are configured to respectively switch on or off to power on or off one or more of the plurality of windings.

4. The system of claim 1, wherein powering on or off one or more of a plurality switches powers on or off a 3-phase windings with sinusoidal voltages of a linear synchronous motor for propelling the vehicle.

5. The system of claim 1, wherein the power storage unit comprises a rechargeable battery configured to provide the vehicle with on-board power.

6. The system of claim 1, wherein the inductive power received at the plurality of receivers provides a plurality of voltages that are indicative of the position of the vehicle.

7. The system of claim 6, wherein the controller is coupled to an accelerometer configured to provide information about the acceleration of the vehicle

8. The system of claim 7, wherein the controller uses the position of the vehicle indicated by the plurality of voltages to correct an error in the information about the acceleration of the vehicle.

9. The system of claim 1, further comprising at least one of a GPS receiver and an RFID reader that are configured to provide to the controller information about the position of the vehicle.

10. The system of claim 1, further comprising a transmitter configured to transmit the determined position of the vehicle to a wayside receiver coupled to the inductive power source.

11. The system of claim 10, wherein the transmitter is configured to transmit information about velocity of the vehicle and a power level of the power storage unit.

12. The system of claim 10, wherein the wayside receiver is configured to provide information about the position of the vehicle to a wayside controller that is configured to commutate a motor to move the vehicle and configured to selectively power on one or more windings to transfer power to the plurality of receivers.

13. The system of claim 1, wherein the controller is further configured to obtain information about the position of the vehicle from an RFID reader that is configured to read one or more markers located outside the vehicles to identify the position of the vehicle relative to the inductive power source.

14. The system of claim 13, wherein the controller is further configured to compare position information from the RFID to the position information derived from at least one of the inductive power and acceleration of the vehicle.

15. The system of claim 14, wherein the controller is configured to identify a fault in measurement of the position of the vehicle when comparing the position information results in a difference that exceeds a predetermined threshold.

16. The system of claim 1, wherein the controller is configured to derive the position information from the acceleration of the vehicle during a period of disruption in the reception of the inductive power at the plurality of receivers.

17. A method of determining a position of a moving vehicle, the method comprising:
receiving at a plurality of receivers inductive power from an inductive power source; and
determining a position of the vehicle relative to a position of the inductive power source based on position information derived from the inductive power received at the plurality of receivers and based on acceleration of the vehicle.

18. The method of claim 17, further comprising estimating a vehicle position from at least one of a GPS receiver and an RFID reader, the RFID reader configured to read one or more markers located outside the vehicle.

19. The method of claim 18, further comprising updating the vehicle position based on the estimate of vehicle position.

20. The method of claim 18, further comprising comparing the vehicle position estimate to the position determined from at least one of the inductive power received at the plurality of receivers and the acceleration of the vehicle.

21. The method of claim 19, further comprising identifying a fault in measurement of the position of the vehicle based on the comparison of the vehicle position estimate to the position determined from at least one of the inductive power received at the plurality of receivers and the acceleration of the vehicle.

22. The method of claim 17, further comprising correcting an error in the information about the acceleration of the vehicle based the position determined of the vehicle.

23. A system for determining a position of a moving vehicle, the system comprising:
means for receiving at a plurality of receivers inductive power from an inductive power source; and
means for determining a position of the vehicle relative to a position of an inductive power source based on position information derived from the inductive power received at the plurality of receivers and based on acceleration of the vehicle.

24. The system of claim 23, further comprising:
means for estimating a vehicle position from at least one of a GPS receiver and an RFID reader, the RFID reader configured to read one or more markers located outside the vehicle;
means for updating the vehicle position based on the estimate of vehicle position;
means for comparing the vehicle position estimate to the position determined from at least one of the inductive power received at the plurality of receivers and the acceleration of the vehicle; and
means for identifying a fault in measurement of the position of the vehicle based on the comparison of the vehicle position estimate to the position determined from at least one of the inductive power received at the plurality of receivers and the acceleration of the vehicle.
